(19) United States
(12) Patent Application Publication
(10) Pub. No.: US 2020/0229898 A1
(43) Pub. Date: Jul. 23, 2020

(54) WIRE MESH COMPOSITE PROSTHESIS

(71) Applicants: Melikset Litvinovich MELIKYAN, New York, NY (US); Karine Meliksetovna MELIKYAN, New York, NY (US); Garegin Meliksetovich MELIKYAN, Moscow (RU)

(72) Inventors: Melikset Litvinovich MELIKYAN, New York, NY (US); Karine Meliksetovna MELIKYAN, New York, NY (US); Garegin Meliksetovich MELIKYAN, Moscow (RU)

(21) Appl. No.: 16/841,053

(22) Filed: Apr. 6, 2020

Related U.S. Application Data
(63) Continuation-in-part of application No. 15/115,716, filed on Apr. 30, 2018, now Pat. No. 10,610,331.

(30) Foreign Application Priority Data
Mar. 13, 2014 (RU) RU 2014109673

(51) Int. Cl. A61C 5/35; A61C 13/09

(52) U.S. Cl. CPC A61C 5/35; A61C 13/09

(57) ABSTRACT

The invention relates to the field of dentistry. The present invention according to the first aspect provides a lightweight, durable monolithic bend-resistant dental prosthesis intended to eliminate of tooth defects, such as missing coronal portion at the gumline, 2 mm above the gumline and below the gumline which comprises a double coronal-root reinforcing, supporting part and a dental restorative material part. The dental restorative material part encapsulates the coronal part of the double coronal-root reinforcing, supporting part. The double coronal-root reinforcing, supporting part comprises at least one expanding frame and a mesh coronal-root frame positioned in the root and coronal parts of the double coronal-root reinforcing, supporting part. The at least one expanding frame comprises a plurality of wires, and the at least one expanding frame is directed by its wider part to an end part of the dental restorative material part far from the root part of the double coronal-root reinforcing, supporting part.

### CROSS-REFERENCE TO RELATE D APPLICATIONS

This application is a continuation-in-part of U.S. application Ser. No. 15/118,716 filed on Apr. 30, 2018, which was a 371 of International application No. PCTRU2015/000135 filed on Mar. 4, 2015, which claims priority benefits to Russian patent application No. RU 2014109673 filed on Mar. 13, 2014. Each of these applications are incorporated herein by reference for all purposes.

### BACKGROUND OF THE INVENTION

The invention relates to the field of dentistry. The claimed wire mesh composite prosthesis is a lightweight durable monolithic bend-resistant prothesis designed for elimination of tooth defects, such as missing coronal portion at the gumline, 2 mm above the gumline and below the gumline—the point where a tooth cannot be restored by traditional methods and have to be extracted. Currently, reinforced composite restoration/reconstruction of teeth according to M. L. Melikyan have been used successfully in dental practice. Scientific and clinical studies of the properties of the reinforced composite material have enabled the expansion of the scope of its application in different clinical situations.

The known methods, dental prosthesis for restoration of the coronal portion of teeth, which were developed by M. L. Melikyan in collaboration with G. M. Melikyan and K. M. Melikyan, are direct restorations/reconstructions of the coronal portion of teeth. The essence of inventions is to restore and reinforce the integrity of the missing tooth as well as function and morphology of missing tooth structures with the use of gold-plated mesh strengthener and resin-based composite material, Patents for inventions RU 2262904, RU 2276594, RU 2233641, RU 2282418, RU 2238698, RU 2253402, RU 2252729, et al. cover a variety of clinical situations.

In particular, the patent for invention RU 2262904 describes the direct restoration of lateral teeth in case of a complete destruction of the coronal portion with the use of composite materials and a reinforcing mesh. The dental mesh is used to form a reinforcing crown-amortizing frame assembly, which is retained, against the root of the tool by means of a reinforcing wire-adhesive pin with an apical end made of wires with the thickness of 0.6 mm that are curved in half. The root of the wire-adhesive pin is inserted into the root canal cavity through the perforation of the frame assembly and is retained with the use of glass-ionomer cement while the top portion of the pin, which is in the form of ongoing wires of its intracanal portion, is distributed and retained on the surface of the crown-amortizing frame assembly below the gumline with subsequent filling of the frame cavity with glass-ionomer cement to the gumline. The coronal portion of the tooth from the gumline to the tubercle line is made with the use of microfill composite materials while the tubercles are restored with the use of macrofill composite materials,

The monolithic reinforced composite coronal portion of the tooth is retained against the root of the tooth with a pin can withstand a prolonged mastication load owing to the increased stability due to the design features of the wire-adhesive pin and its retention method as well as exhibits an increased strength due to the root canal reinforcement effect and to the composite material of the coronal portion of the tooth.

Benefits of restoration of lateral teeth with the use of the known method:

the intracanal portion of the pin provides for canal reinforcement;

the weaving of the wires of the intracanal portion of the pin, and the passive retention of the pin prevent the occurrence of stress in the root, canal and so eliminate root fracturing under the impact of functional loading;

the penetration of the glass-ionomer cement between pin wire weaving provides for a through connection between the cement and the root walls;

the top wire portion of the pin provides for an additional mechanical retention of the reinforcing crown-amortizing frame assembly and the root base and ensures a secure fixing of the restored coronal portion of the tooth to the roots of the teeth;

the top wire portion of the pin provides for dual reinforcement of the area of the root base up to the gumline;

the top wire portion of the pin is located at the gumline or below inside the amortizing cavity of the root base, which provides for restoration of the coronal portion of the tooth in total compliance with its anatomical structure.

The disadvantage of composite restoration/reconstruction is the polymerization shrinkage of the composite material, which reaches 2-5 pet of the volume. This shrinkage is due the reduction of the distance between monomer molecules in the course of a polymeric chain creation. Hardening of the composite material under the influence of light or as the result of a chemical reaction leads to condensation of monomer molecules, which creates a polymeric chain. The polymerization rate of the composite material depends on a number of factors: it is largely dependent on the amount of the initiator, the temperature, and the illumination time and intensity. It is also dependent on the color and the transparency of the composite material (A. B. Borisenko, V. P. Nespryadko “Composite Filling and Facing Materials.” Kiev, Kniga Plus, 2001, pp. 17-21). In this case, the studies of physical and chemical properties of the composite material demonstrate that, if shrinkage of the composite material is accepted at 100 pct., the material shrinks by 60 pct. of its initial volume in the first minute, by another 15 pct. after 5 minutes, and by the remaining 25 pct. during the first day (S. K. Surzhansky et al., “Restoration Materials and Foundations of Practical Endodology”. Kiev, Kniga Plus, 2004, p. 28).

In the practice of dentistry, the residual effects of polymerization shrinkage of composite materials can lead to fragmentation of the dentition in case of direct restoration/reconstruction of the missing coronal portion of the tooth. This may lead to creation of a gap between the approximal surfaces of the restored composite tooth and adjacent approximal surfaces of adjacent natural teeth. The dentition dissociation has a negative impact on the stability and the strength of the recovered composite tooth under the influence of mastication loads. Reinforcement of composite materials in case of direct restoration/reconstruction reduces the risk of occurrence of residual symptoms of polymerization shrinkage but does not eliminate it completely. Residual polymerization shrinkage adversely affects the aesthetic'appeal of the restored composite tooth. In case of implementation of known techniques of restoration/reconstruction of missing coronal portion of a tooth with the use of composite materials, grinding and polishing of the composite structure are implemented in the final stage of the restoration/reconstruction. Removal of the roughness on the surface of restoration/reconstruction is aimed at reducing the absorbent properties of the composite material. Penetration (retention) of food-grade dyes or water reaches a depth from 3 to 5 microns. The presence of residual effects of polymerization shrinkage and inaccessible areas for high-quality polishing and grinding over the entire surface of the restored composite tooth in case of direct restoration/reconstructions can lead to changes in the color of the surface layer of the restoration and to its increased abrasion.

Further, some known dental prostheses use separate straight wires which form a dome-shaped frame by using a large number of additional fixing elements in order to fix the shape of this frame, which results in insufficient stability of such frame. Also, in the known dental prostheses, a root base is reinforced only with a metal mesh or a metal perforated plate. This area is flexible in bending under functional loads, which can lead to fractures in the root base area, Furthermore, in the known dental prostheses, a fixing portion of a reinforcing pin is represented by a metal mesh or a perforated plate at a root base and a fastening element in a root canal, which does not provide reliable fixation and does not exclude occurrence of rotation of a restored tooth. Besides, a frame in the known dental prostheses is located only at the level of a coronal portion of a tooth, which does not prevent occurrence of fractures in a transition region between the root portion and the coronal portion.

Thus, constructions of the known dental prostheses may lead to occurrence of fractures in the dental prostheses and to rotation of the dental prostheses.

### SUMMARY OF THE INVENTION

The wire mesh composite prosthesis is a lightweight durable monolithic bend-resistant prosthesis that designed to eliminate severe tooth defects such as missing coronal part of the tooth at the gumline, 2 mm above the gumline and below the gumline. Missing coronal part of tooth below the gumline is a point where a tooth is not unsuitable for traditional restoration and cannot be restored by the known dental prostheses. It is a reason for the tooth extraction. The claimed lightweight durable monolithic bend-resistant dental prosthesis allows the preservation of root/roots and periodontal ligament that always removed during an extraction and cannot be recovered after that procedure. Along with that tooth extraction is associated with loss of alveolar bone and usage of the claimed prosthesis prevents from that highly negative consequence.

The present invention according to the first aspect provides a lightweight durable monolithic bend-resistant dental prosthesis intended for restoring a tooth, which comprises a double coronal-root reinforcing supporting part and a dental restorative material part. The double coronal-root reinforcing supporting part has a root part corresponding to a root part of the tooth to be restored and a coronal part corresponding to a coronal part of the tooth to be restored, while the dental restorative material part corresponds to the coronal part of the tooth to be restored and encapsulates the coronal part of the double coronal-root reinforcing supporting part. The double coronal-root reinforcing supporting part comprises at least one expanding frame and a mesh coronal-root frame positioned in the root and coronal parts of the double coronal-root reinforcing supporting part. The at least one expanding frame comprises a plurality of wires, and the at least one expanding frame is directed by its wider part to an end part of the dental restorative material part which is farthest from the root part of the double coronal-root reinforcing supporting part.

The present invention according to the second aspect provides a lightweight durable monolithic bend-resistant dental prosthesis intended for restoring a tooth, which comprises a double coronal-root reinforcing supporting part having a root part corresponding to a root part of the tooth to be restored and a coronal part corresponding to a coronal part of the tooth to be restored, and a dental restorative material part corresponding to the coronal part of the tooth to be restored and encapsulating the coronal part of the double coronal-root reinforcing supporting part. The double coronal-root reinforcing supporting part comprises at least one pin and a mesh coronal-root frame positioned in the root and coronal parts of the double coronal-root reinforcing supporting part.

The present invention according to the third aspect provides a lightweight durable monolithic bend-resistant dental prosthesis intended for restoring a tooth, which comprises a coronal-root reinforcing supporting part having a root part corresponding to a root part of the tooth to be restored and a coronal part corresponding to a coronal part of the tooth to be restored, and a dental restorative material part corresponding to the coronal part of the tooth to be restored and encapsulating the coronal of the coronal-root reinforcing supporting part. The coronal-root reinforcing supporting part comprises a mesh coronal-root frame positioned in the root and coronal parts of the double coronal-root reinforcing supporting part.

The present invention according to the fourth aspect provides a lightweight durable monolithic bend-resistant dental prosthesis intended for restoring, a tooth, which comprises a double coronal-root reinforcing supporting part having a root part corresponding to a root, part of the tooth to be restored and a coronal part corresponding to a coronal part of the tooth to be restored, and a dental restorative material part corresponding to the coronal part of the tooth to be restored and encapsulating the coronal part of the double coronal-root reinforcing supporting part. The double coronal-root reinforcing supporting part comprises at least one expanding, frame and a wire frame. The at least one expanding frame comprises a plurality of wires, and the at least one expanding is directed by its wider part to an end part of the dental restorative material part which is farthest from the root part of the double coronal-root reinforcing supporting part.

The present invention according to the fifth aspect provides a lightweight durable monolithic bend-resistant dental prosthesis intended for restoring a tooth, which comprises a double coronal-root reinforcing supporting part having a root part corresponding to a root part of the tooth to be restored and a coronal part corresponding to a coronal part of the tooth to be restored, and a dental restorative, material part corresponding to the coronal part of the tooth to be restored and encapsulating the coronal part of the double coronal-root reinforcing supporting part. The double coronal-root reinforcing supporting part comprises at least one pin and a wire frame.

The present invention according to the sixth aspect provides a lightweight durable monolithic bend-resistant dental prosthesis intended for restoring a tooth, which comprises a double coronal-root reinforcing supporting part having a root part corresponding to, a root part of the tooth to be restored and a coronal part corresponding to a coronal part of the tooth to be restored, and a dental restorative material part corresponding to the coronal part of the tooth to be restored and encapsulating the coronal of the double coronal-root reinforcing supporting part. The double coronal-root reinforcing supporting part comprises a mesh coronal-root tube positioned in the root and coronal parts of the double coronal-root reinforcing supporting part and a mesh coronal-root frame positioned in the root and coronal parts of the double coronal-root reinforcing supporting part.

The present invention according to the seventh aspect provides a lightweight durable monolithic bend-resistant dental prosthesis intended for restoring a tooth, which comprises a double coronal-root reinforcing supporting part having a root part corresponding to a root part of the tooth to be restored and a coronal part corresponding to a coronal part of the tooth to be restored, and a dental restorative material part corresponding to the coronal part of the tooth to be restored and encapsulating the coronal part of the double coronal-root reinforcing supporting part. The double coronal-root reinforcing supporting part comprises at least one expanding frame and a spring like wire positioned in the coronal part of the double coronal-root reinforcing supporting part. The at least one expanding frame comprises a plurality of wires, and the at least one expanding frame is directed by its wider part to an end part of the dental restorative material part which is farthest from the root part of the double coronal-root reinforcing supporting part.

The present invention according to the eighth aspect provides a lightweight durable monolithic bend-resistant dental prosthesis intended for restoring a tooth, which comprises a double coronal-root reinforcing supporting part having a root part corresponding to a root part of the tooth to be restored and a coronal part corresponding to a coronal part of the tooth to be restored, and a dental restorative material part corresponding to the coronal part of the tooth to be restored and encapsulating the coronal part of the double coronal-root reinforcing supporting part. The double coronal-root reinforcing supporting part comprises at least one pin and a spring like wire positioned in the coronal part of the double coronal-root reinforcing supporting part.

The present invention according to the ninth aspect provides a lightweight durable monolithic bend-resistant dental prosthesis intended for restoring a tooth, which comprises a double coronal-root reinforcing supporting part having a root part corresponding to a root part of the tooth to be restored and a coronal part corresponding to a coronal part of the tooth to be restored, and a dental restorative material part corresponding to the coronal part of the tooth to be restored and encapsulating the coronal part of the double coronal-root reinforcing supporting part. The double coronal-root reinforcing supporting part comprises at least one expanding frame and a plurality of rounded wires not contacting each other and positioned in the coronal part of the double coronal-root reinforcing supporting part. The at least one expanding frame comprises a plurality of wires, and the at least one expanding frame is directed by its wider part to an end part of the dental restorative material part which is farthest from the root part of the double coronal-root reinforcing supporting part.

The present invention according to the tenth aspect provides a lightweight durable monolithic bend-resistant dental prosthesis intended for restoring a tooth, which comprises a double coronal-root reinforcing supporting part having a root part corresponding to a root part of the tooth to be restored and a coronal part corresponding to a coronal part of the tooth to be restored, and a dental restorative material part corresponding to the coronal part of the tooth to be restored and encapsulating the coronal part of the double coronal-root reinforcing supporting part. The double coronal-root reinforcing supporting part comprises at least one pin and a plurality of rounded wires not contacting each other and positioned in the coronal part of the double coronal-root reinforcing supporting part.

The present invention according to the eleventh aspect provides a lightweight durable monolithic bend-resistant dental prosthesis intended for restoring a tooth, which comprises a double coronal-root reinforcing supporting part having a root part corresponding to ;,a root part of the tooth to be restored and a coronal part corresponding to a coronal part of the tooth to be restored, and a dental restorative material part corresponding to the coronal part of the tooth to be restored and encapsulating the coronal part of the double coronal-root reinforcing supporting part. The double coronal-root reinforcing supporting part comprises at least one cone-shaped frame positioned in the root and coronal parts of the double coronal-root reinforcing supporting part and a coronal supporting part positioned in the coronal part of the double coronal-root reinforcing supporting part. The at, least one cone-shaped frame comprises a plurality of wires, and the at least one cone-shaped frame is directed by its wider part to an end part of the dental restorative material part which is farthest from the root part of the double coronal-root reinforcing supporting part.

The present invention according to the twelfth aspect provides a lightweight durable monolithic bend-resistant dental prosthesis intended for restoring a tooth, which comprises a coronal-root reinforcing supporting part having a root part corresponding to a root part of the tooth to be restored and a coronal part corresponding to a coronal part of the tooth to be restored, and a dental restorative material part corresponding to the coronal part of the tooth to be restored and encapsulating the coronal part of the coronal-root reinforcing supporting part. The coronal-root reinforcing supporting part comprises at least one cone-shaped frame positioned in the root and coronal parts of the coronal-root reinforcing supporting part. The at least one cone-shaped frame comprises a plurality of wires, and the at least one cone-shaped frame is directed by its wider part to an end part of the dental restorative material part which is farthest from the root part of the coronal-root reinforcing supporting part.

The claimed invention solves the problem of excluding the impact of the polymerization shrinkage and unwanted clinical consequences: crack propagation, marginal failure, decreased bond strength etc. The claimed dental prothesis provides the following technical effects: increase of bending strength and compression, ensuring the stability and durability of the restored tooth. Since shrinkage creates stresses leading to restoration displacement and fracture and staining, elimination of these deficiencies expands the lifespan of the restored teeth and improve the aesthetics.

The claimed lightweight durable monolithic bend-resistant dental prosthesis according to M. L. Melkyan provides number of advantages that distinguish that construction from the known direct restorations/reconstructions of the coronal part of the tooth with the use of reinforcing dental restorative materials and from the conventional prosthetics. The claimed prosthesis comprises double reinforcing supporting parts that are connected to each other, resin-based dental restorative material and hard tissue of the restoring tooth. The combination of reinforcing supporting parts, resin-based dental restorative material and dental cement combine their physical and chemical properties, forming an indivisible monolithic system, resistant to compression and bending.

### BRIEF DESRIPTION OF THE DRAWINGS

The present invention can be best understood in conjunction with the following non-limiting drawings in which:

FIG. 1a is a side view of the fan-shaped coronal-root frame of the double coronal-root reinforcing supporting part in the lightweight durable monolithic bend-resistant dental prosthesis according to an embodiment of the present invention;

FIG. 1b is a front view of the fan-shaped coronal-root frame shown in FIG. 1a:

FIG. 2a is a side view of the mesh coronal-root frame of the double coronal-root reinforcing supporting part in, the lightweight durable monolithic bend-resistant dental prosthesis according to an embodiment of the present invention;

FIG. 2b is a front view of the mesh coronal-root frame shown in FIG. 2a;

FIG. 3a is a side view of the double coronal-root reinforcing supporting part of the dental prosthesis according to an embodiment of the present invention;

FIG. 3b is a front view of the double coronal-root reinforcing supporting part of the dental prosthesis shown in FIG. 3a;

FIG. 4a is a side view of the lightweight durable monolithic bend-resistant dental prosthesis according to an embodiment of the present invention;

FIG. 4b is a front view of the lightweight durable monolithic bend-resistant dental prosthesis shown in FIG. 4a;

FIG. 5 is a front view of the fan-shaped coronal-root frame of the double coronal-root reinforcing supporting part of the lightweight durable monolithic bend-resistant dental prosthesis, according to another embodiment of the present invention:

FIG. 6 is a front view of the mesh coronal-root frame of the double coronal-root reinforcing supporting part of the lightweight durable monolithic bend-resistant dental prosthesis according to another embodiment of the present invention:

FIG. 7 is a front view of the double coronal-root reinforcing supporting part of the dental prosthesis according to another embodiment of the present invention;

FIG. 8 is a front view of the lightweight durable monolithic bend-resistant dental prosthesis according to another embodiment of the present invention.

### DETAILED DES RIPTION OF THE INVENTION

Embodiments of the claimed lightweight durable monolithic bend-resistant dental prosthesis will be further described in more detail, which shall not be in any way considered as limiting the present invention.

In the present disclosure, the term wire relates to both to metal wires and nonmetal wires, and the lightweight durable monolithic bend-resistant dental prosthesis can be also referred to as a wire mesh composite prosthesis

The provided lightweight durable monolithic bend-resistant dental prosthesis is used for restoration of all types of teeth with damages 2 mm above a gumline, at a gumline and/or below a gumline. As it is known, different types of teeth have different number of roots, which depends on a shape, and position of a tooth in an oral cavity. For example, incisors and canines usually have a single root, premolars usually have one or two roots, and molars usually have roots in the quantity of three to four. The provided lightweight durable monolithic bend-resistant dental prosthesis can be implemented for a direct dental restoration (the dental prosthesis is formed directly in an oral cavity) or for an indirect dental restoration (the dental prosthesis is formed outside an oral cavity).

A lightweight durable monolithic bend-resistant dental prosthesis intended for restoring a tooth according to the first aspect of the present invention comprises a double coronal-root reinforcing supporting part and a dental restorative material part. The double coronal-root reinforcing supporting part has a root part corresponding to a root part of the tooth to be restored and a coronal part corresponding to a coronal part of the tooth to be restored, while dental restorative material part corresponds to the coronal part of the tooth to be restored and encapsulates the coronal part of the double coronal-root reinforcing supporting part The double coronal-root reinforcing supporting part comprises at least one expanding frame and a mesh coronal-root frame positioned in the root and coronal parts of the double coronal-root reinforcing supporting part. The at least one expanding frame comprises a plurality of wires, and the at least one expanding frame is directed by its wider part to an end part of the dental restorative material part which is farthest from the root part of the double coronal-root reinforcing supporting part.

The at least one expanding frame of the double coronal-root reinforcing supporting part can comprise or represent at least one fan-shaped frame, at least one cone-shaped frame, or expanding frames of any other forms suitable for using in the claimed prosthesis.

Further, the expanding frames comprising a plurality of wires can have different configurations in the double coronal-root reinforcing supporting part, as described below.

In one configuration, the wires of the at least one expanding frame are connected by their ends in the root part of the double coronal-root reinforcing supporting part such that they form the wider part of the at least one expanding frame ending in the coronal part of the double coronal-root reinforcing supporting part.

In another configuration, the wires of the at least one expanding frame are connected by their ends in the root part of the double coronal-root reinforcing supporting part such that they form the wider part of the at least one expanding frame ending in the root part of the double coronal-root reinforcing supporting part.

In yet another configuration, the wires of the at least one expanding frame are connected by their ends in the coronal part of the double coronal-root reinforcing supporting part such that they form the wider part of the at least one expanding, frame ending in the coronal part of the double coronal-root reinforcing supporting part.

Further, the wires of the least one expanding frame can be U-bent in the middle such that bent ends of the wires form the wider part of the at least one expanding frame, and at least, the following configurations can be used.

In one configuration, the wires of the at least one expanding frame are U-bent in the middle such that bent ends of the wires are located at a distance from each other and form the wider part of the at least one expanding frame ending in the coronal part of the double coronal-root reinforcing supporting part, and free ends of the wires, opposite to the bent parts, are connected in, the root part of the double coronal-root reinforcing supporting part.

In another configuration, the wires of the at least one expanding frame are U-bent in the middle such that bent ends of the wires are located at a distance from each other and form the wider part of the at least one expanding frame ending in the coronal part of the double coronal-root reinforcing supporting part, and free ends of the wires, opposite to the bent parts, are connected in the coronal part of the double coronal-root reinforcing supporting part.

In yet another configuration, the wires of the at least one expanding frame are U-bent in the middle such that bent ends of the wires are located at a distance from each other and form the wider part of the at least one expanding frame ending in the root part of the double coronal-root reinforcing supporting part, and free ends of the wires, opposite to the bent parts, are connected in the root part of the double coronal-root reinforcing supporting part.

Further, the wires of the least one expanding frame can be U-bent in the middle such that free ends of the wires form the wider part of the at least one, expanding frame, and at least the following configurations can be used.

In one configuration, the wires of the at least one expanding frame are U-bent in the middle such that bent ends of the wires are connected in the root part of the double coronal-root reinforcing supporting part, and free ends of the wires, opposite to the bent parts, are located at a distance from each other and form the wider part of the at least one expanding frame ending in the coronal part of the double coronal-root reinforcing supporting part.

In another configuration, the wires of the at least one expanding frame are U-bent in the middle such that bent ends of the wires are connected in the root part of the double coronal-root reinforcing supporting part, and free ends of the wires, opposite to the bent parts, are located at a distance from each other and form the wider part of the at least one expanding frame ending in the root part of the double coronal-root reinforcing supporting part.

In yet another configuration, the wires of the at least one expanding frame are U-bent in the middle such that bent ends of the wires are connected in the coronal part of the double coronal-root reinforcing supporting part, and free ends of the wires, opposite to the bent parts, are located at a distance from each other and form the wider part of the at least one expanding frame ending in the coronal part of the double coronal-root reinforcing supporting part.

It should be noted that the wires of the least one expanding frame in any of the configurations of this aspect on any other aspects, where applicable, can be U-bent not only in the middle, but also at any point of their length.

Some embodiments of the lightweight durable monolithic bend-resistant dental prosthesis intended for restoring a tooth according to the fist aspect of the present invention are illustrated below by way of examples.

### EXAMPLE 1

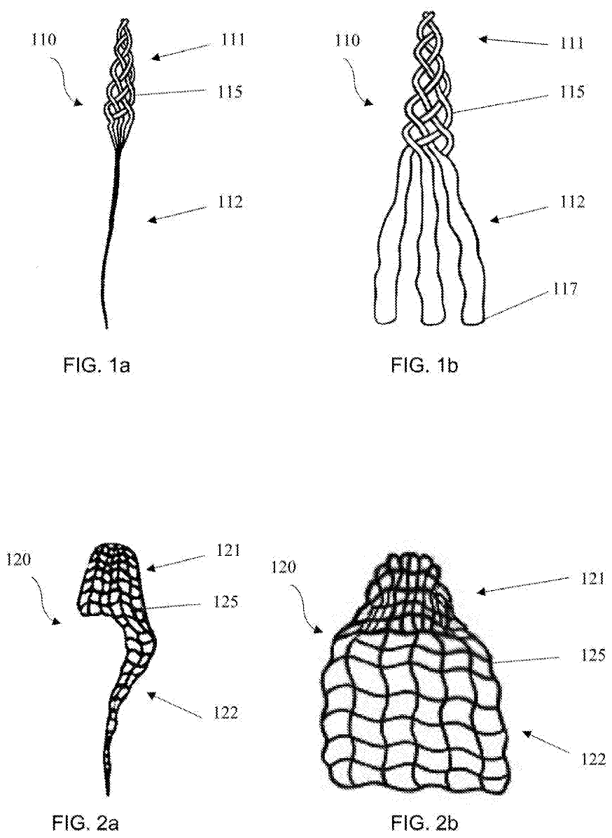

The lightweight durable monolithic bend-resistant dental prosthesis 100 according to example 1 is illustrated in FIGS. 1-4 and is, intended to restore/reconstruct an incisor and comprises a double coronal-root reinforcing supporting part 140 and a dental restorative material part 130. FIGS. 4a, 4b show a side view and a front view of the dental prosthesis 100. In this example, the dental restorative material part 130 comprises a composite material, however, in other examples it can comprise compomer material and/or others dental restorative materials. The dental prosthesis 100 has a root part, also known as a truncated conical cavity of the dental prosthesis, and a coronal part, which correspond to similar anatomical parts of a tooth to be restored, i.e. a root and coronal parts of the tooth to be restored.

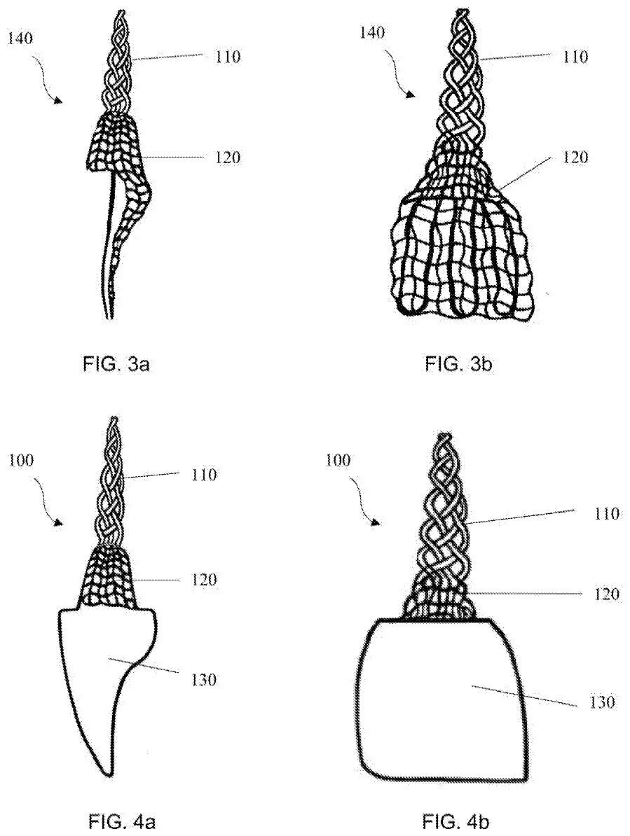

The double coronal-root reinforcing supporting part 140 (FIGS. 3a, 3b show a side view and a front view of the double coronal-root reinforcing supporting part 140) of the dental prosthesis 100 consists of two parts which are a flexible fan-shaped frame 110 having a root part and a coronal part and a mesh coronal-root frame 120 having a root pert and a coronal part. The dental restorative material part 130 encapsulates only the coronal parts of the fan-shaped frame 110 and the mesh coronal-root frame 120. In this example, the fan-shaped frame 110 and the mesh coronal-root frame 120 relate both to the root part and the coronal part of the dental prosthesis. It is important to note that the lightweight durable monolithic bend-resistant dental prosthesis in other examples can have more than one fan-shaped frame, and their amount generally depends on the number of roots of a tooth to be restored.

The flexibility of both parts of the double coronal-root reinforcing supporting part increases adaptive properties and customization of the claimed prosthesis and, as a result, increases its load-bearing properties. The mobility and flexibility of both parts of the double coronal-root reinforcing supporting part also allows implementing variety of designs of the future prosthesis, determining universality of the claimed prosthesis.

It is to note that in other embodiments fan-shaped frames and mesh frames can be implemented as not flexible frames, i.e. as rigid frames.

Returning to the parts of the double coronal-root reinforcing supporting part in this example, the fan-shaped frame 110 (FIGS. 1a, 1b show a side view and a front view of the fan-shaped frame 110) has an elongated form and comprises a plurality of wires 115 taken as a strand of wires. The fan-shaped frame 110 has an apical part 111 and a main part 112 wider than the apical part 111 in one plane, which means that the wires 115 are positioned in the fan-shaped frame 110 in such way that they form a fan shape substantially in one plane. The apical part 111 is the root part of the fan-shaped frame 110, meaning that the apical part 111 of the fan-shaped frame 110 relates to the root of a tooth to be restored, and the main part 112 is the coronal part of the fan-shaped frame 110.

In some embodiments, the main part of the fan-shaped frame can also relate only to the, coronal part of the dental prosthesis, or both to the root part and, to the coronal part of the dental prosthesis, as partly described by the description of the configuration of the expanding frames given above.

According to this example of the prosthesis 100, the wires 115 of the fan-shaped frame 110 are crimped metal wires which are U-bent in the middle such that bent ends 117 of the wires 115 are located at a distance from each other and define a fan shape of the main part 112 of the fan-shaped frame 110. Further, the bent ends 117 of the wires 115 are located in the coronal part of the dental prosthesis 100 in the direction of masticatory surface or a cutting edge of the coronal part, while free ends of the wires 115, which are opposite to the bent parts 117 of these wires, are twisted together and define the apical part 111 of the fan-shaped frame 110. In this example, the bent ends 117 of the wires 115 are positioned in 2-2.5 mm from a cutting edge of the dental prosthesis 100 (a so-called top of the coronal part). It is to note that use of crimped wires provides that the wires 115 do not move in relation to each other meaning that the double coronal-root reinforcing supporting part 140 has a necessary stability in its construction.

It is to note that in other examples the bent ends of the wires of the fan-shaped frame can be located in the root part of the dental prosthesis instead of the coronal part.

The main part 112 of the fan-shaped frame 110 has a fan shape forming an angle between 5 degrees and 85 degrees depending on anatomy of a tooth to be restored. Further, the wires 115 of the fan-shaped frame 110 in its main part 112 are positioned at the same angle with respect to each other. It is to note that in some examples the wires of the fan-shaped frame can be positioned in its main part at different angles with respect to each other which can be necessary depending on a tooth to be restored and/or for providing additional strength characteristics to the dental prosthesis 100. It is to note, that in some examples of the claimed dental prosthesis intended for restoring molars and premolars, angles between the wires of the fan-shaped frame can change after arranging the dental prosthesis in a correspondent place in an oral cavity with the purpose of restoring a tooth.

It is to note that in other examples not all wires of the fan-shaped frame can represent crimped wires, and the wires may represent non-metal wires or a combination of metal wires and non-metal wires. In some examples, at least some of the wires have metal parts and non-metal parts. Also, in some examples, at least part of the wires of the fan-shaped frame represent gold-plated wires.

Returning to the described example, the mesh coronal-root frame 120 (FIGS. 2a, 2b show a side view and a front view of the fan-shaped frame 110) of the double coronal-root reinforcing supporting part 140 is manufactured from a metal mesh 125 and has a configuration depending on a kind of a tooth to be restored. It should be noted that in other examples the mesh coronal-root frame can be partially of fully manufactured from a non-metal mesh. In this examples, since the dental prosthesis 100 is intended to restore an incisor, the mesh coronal-root frame 120 can have a form representing a convex bottom narrow apical part 121 having an apical hole, which relates to a precervical section of the incisor, and the convex bottom narrow apical part 121 continues with a side part 122 resembling one of the side walls of the incisor. The convex bottom narrow apical part 121 is the root part of the mesh coronal-root frame 120, and the side part 122 is the coronal part of the mesh coronal-root frame 120. Such construction of the dental prosthesis means that the mesh coronal root frame 120 in the claimed dental prosthesis 100 is positioned not only below a gumline of the restored tooth, i.e. in the root part, but also above it, i.e. in the coronal part, and thus the dental prosthesis 100 reinforce the most dangerous part in terms of possibility of occurrence of fractures, which is a transition part from the root part to the coronal part. In the claimed dental prosthesis 100, there is no need to have any additional elements for the double coronal-root reinforcing supporting part 140 to connect it with hard tissues of the tooth to be restored.

In some examples, at least part of the mesh coronal-root frame comprises a gold-plated mesh, which provides, among other things, better aesthetics characteristics of the dental prosthesis. In other examples, at least part of the mesh coronal-root frame comprises a woven mesh made from crimped wires. The woven mesh provides capability of forming such mesh in any suitable form and a stable structure of the mesh.

The fan-shaped frame 110 passes through the apical hole of the mesh coronal-root frame 120, and the convex bottom narrow apical part 121 of the mesh coronal-root frame 120 surrounds the apical part 111 of the fan-shaped frame 110. Optionally, ends of the wires 115 of the fan-shaped frame 110 are pressed against an inner surface of the mesh coronal-root frame 120.

Thus, in this example, the double coronal-root reinforcing supporting part 140 of the dental prosthesis 100 represents the fan-shaped frame 110 and the mesh coronal-root frame 120 which are aligned in the longitudinal direction of the dental prosthesis 100 and located in both the root and coronal part of the dental prosthesis. The dental prosthesis 100 at one of its ends relating to its root part has the apical part 111 of fan-shaped frame 110 and at another end the dental prosthesis 100 has a surface of the dental restorative material part 130 which encapsulates a part of the mesh coronal-root frame 120 and a part of the fan-shaped frame 110 and forms the coronal part of the dental prosthesis. Shapes and dimensions of the fan-shaped frame 110 and the mesh coronal-root frame 120 are conditioned by a tooth to be restored by the dental prosthesis 100 and may vary. It is important to note that a dental restorative material in the dental restorative material part 130 can polymerize.

In the claimed dental prosthesis 100, the coronal part is reinforced riot only with the mesh coronal-root frame 120, but also with the fan-shaped frame 110 to further increase the static-bending strength of the coronal part of the dental prosthesis 100. Further, considering that a root base in the dental prosthesis 100 is reinforced not only with the mesh coronal-root frame 120, but additionally with the fan-shaped frame 110, this eliminates possibility of fractures in the root base region, prevents rotation of the dental prosthesis 100 and improves fixation of the dental prosthesis 100. The above advantages of the claimed dental prosthesis 100 provide a uniform distribution of stress under functional loads on preserved solid tissues of a tooth root, eliminate occurrence of local stress on preserved solid tissues of a tooth root under functional loads and eliminate possibility of cracks and fractures of the walls of the truncated conical cavity in the claimed dental prosthesis 100.

Approximal walls of the mesh coronal-root frame 120 located in the coronal part are bent at, right angles to each other on a part from a cervical edge (between the root part and the coronal part) to a cutting edge (top of the coronal part) of the dental prosthesis 100, which subsequently, increases the static-bending strength of the coronal part of the restored tooth. After fitting and correction, a width of the formed approximal walls is 2.5-3 mm in the cervical edge region, 2 mm in the middle third region, and 1-1.5 mm in the cutting-edge region.

It is important to note that for some embodiments of the dental prosthesis intended for restoration of molars and premolars, ends of wires of each fan-shaped frame in its main part may be located at an equator level of the coronal part of the dental prosthesis. Further, in some embodiments, edges of the mesh coronal-root frame are bent outwards or inwards which prevents appearance of tooth marginal fissures.

### EXAMPEL 2

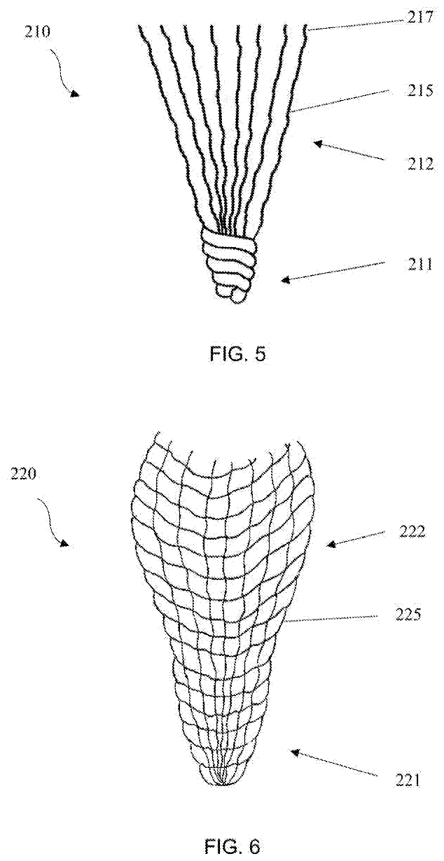

The lightweight durable monolithic bend-resistant dental prosthesis 200 according to example 2 is illustrated in FIGS. 5-8 and is intended for restoration a premolar with one root. This dental prosthesis 200 differs from the, dental prosthesis 100 of the examples 1 described above in that its mesh coronal-root frame 220 (FIG. 6) has an elongated convex form narrowing towards a root part of the dental prosthesis 200. The mesh coronal-root frame 220 is made of a metal mesh 225 and comprises a root part 221 and a coronal part 222.

Also, the construction of the fan-shaped frame 210 (FIG. 5) is different in that its wires 215 are U-bent in the middle such that bent ends of the wires 215 are twisted together and define an apical part 211 of the fan-shaped frame 210, while free ends 217 of the wires 215, opposite to the bent parts, are located at a distance from each other, so as to form a fan shape, and define the main part 212 of the fan-shaped frame 210.

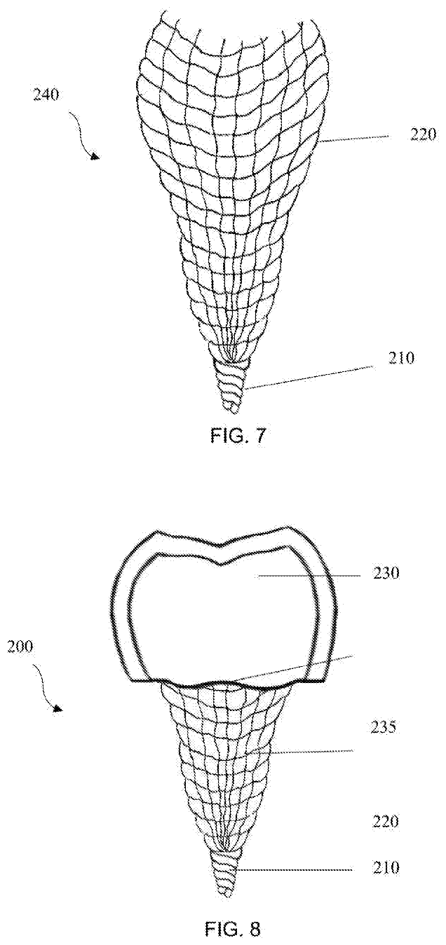

The double coronal-root reinforcing supporting part 240 consisting of the mesh coronal-root frame 220 and the fan-shaped frame 210 is shown in FIG. 7, and the dental prosthesis 200 is shown in FIG. 8 in which a dental restorative material part 230 is shown with its cervical margin 235.

### EXAMPLE 3

A lightweight durable monolithic bend-resistant dental prosthesis according to example 3 is intended for restoration of a multi-rooted permanent tooth with three roots. In this example, the mesh coronal-root frame has an elongated convex form narrowing towards the root part of the dental prosthesis and having three root parts, which enter three roots of the molar to be restored arid correspond to them. Each of the three root parts has an apical hole. Further, this dental prosthesis has three flexible fan-shaped frames each passing through the apical hole in one of the three arms of the mesh coronal-root frame. Construction of each of the three-flexible fan-shaped frames may be either as in the example 1 or as in example 2.

A lightweight durable monolithic bend-resistant dental prosthesis intended for restoring a tooth according to the second aspect of the present invention comprises a double coronal-root reinforcing supporting part having a root pail corresponding to a root part of the tooth to be restored and a coronal part corresponding to a coronal part of the tooth to be restored, and a dental restorative material part corresponding to the coronal part of the tooth to be restored arid encapsulating the coronal part of the double coronal-root reinforcing supporting part. The double coronal-root reinforcing supporting part comprises at least one pin and a mesh coronal-root frame positioned in the root and coronal parts of the double coronal-root reinforcing supporting part. The at least one pin can be, positioned in the root part of the double coronal-root reinforcing supporting part or both in the root and coronal parts of the double coronal-root reinforcing supporting part.

A lightweight durable monolithic bend-resistant dental prosthesis intended for restoring a tooth according to the third aspect of the present invention comprises a coronal-root reinforcing supporting part having a root part corresponding to a root, part of the tooth to be restored and a coronal part corresponding to a coronal part of the tooth to be restored, and a dental restorative material part corresponding to the coronal part of the tooth to be restored and encapsulating the coronal of the coronal-root reinforcing supporting part The coronal-root reinforcing supporting part comprises a mesh coronal-root frame positioned in the root and coronal parts of the double coronal-root reinforcing supporting part.

A lightweight durable monolithic bend-resistant dental prosthesis intended for restoring a tooth according to the fourth aspect of the present invention comprises double coronal-root reinforcing supporting part having a root part corresponding to a root part of the tooth to be restored and a coronal part corresponding to a coronal part of the tooth to be restored, and a dental restorative material part corresponding to the coronal part of the tooth to be restored and encapsulating the coronal part of the double coronal-root reinforcing supporting part. The double coronal-root reinforcing supporting part comprises at least one expanding frame and a wire frame. The at least one expanding frame comprises a plurality of wires, and the at least one expanding is directed by its wider part to an end part of the dental restorative material part which is farthest from the root part of the double coronal-root reinforcing supporting part.

The at least one expanding frame of the double coronal-root reinforcing supporting part can comprise or represent at least one fan-shaped frame, at least one cone-shaped frame, or expanding frames of any other forms suitable for using in the claimed prosthesis.

The wire frame can have, for example, a dome-shaped form directed with its spherical part to an end part of the root part of the double coronal-root reinforcing supporting part which is farthest from its coronal part. Further, the wire frame can be is positioned in the coronal part of the double coronal-root reinforcing supporting part or in both the root and coronal parts of the double coronal-root reinforcing supporting part.

Further, the expanding frames comprising a plurality of wires can have different configurations in the double coronal-root reinforcing supporting part, as described below.

In one configuration, the wires of the at least one expanding frame are connected by their ends in the root part of the double coronal-root reinforcing supporting part such that they form the wider part of the at least one expanding frame ending in the coronal part of the double coronal-root reinforcing supporting part.

In another configuration, the wires of the at least one expanding frame are connected by their ends in the root part of the double coronal-root reinforcing supporting part such that they form the wider part of the at least one expanding frame ending in the root part of the double coronal-root reinforcing supporting part.

Further, the wires of the least one expanding frame can be U-bent in the middle such that bent ends of the wires form the wider part of the, at least one expanding frame, and at least the following configurations can be used.

In one configuration, the wires of the at least one expanding frame are U-bent in the middle such that bent ends of the wires are located at a distance from each other and form the wider part of the at least one expanding frame ending in the coronal part of the double coronal-root reinforcing supporting part, and free ends of the wires, opposite to the bent parts, are connected in the root part of the double coronal-root reinforcing supporting part.

In another configuration, the wires of the at least one expanding frame are U-bent in the middle such that bent ends of the wires are located at a distance from each other and form the wider part of the at least one expanding frame ending in the root part of the double coronal-root reinforcing supporting part, and free ends of the wires, opposite to the bent parts, are connected in the root part of the double coronal-root reinforcing supporting part.

Further, the wires of the least one expanding frame can be U-bent in the middle such that free ends of the wires form the wider part of the at least one expanding frame, and at least the following configurations can be used.

In one configuration, the wires of the at least one expanding frame are U-bent in the middle such that bent ends of the wires are connected in the root part of the double coronal-root reinforcing supporting part, and free ends of the wires, opposite to the bent parts, are located at a distance from each other and form the wider part of the at least one expanding frame ending in the coronal part of the double coronal-root reinforcing supporting part.

In another configuration, the wires of the at least one expanding frame are U-bent in the middle such that bent ends of the wires are connected in the root, part of the double coronal-root reinforcing supporting part, and free ends of the wires, opposite to the bent parts, are located at a distance from each other and form the wider part of the at least one expanding frame ending in the root part of the double coronal-root reinforcing supporting part.

A lightweight durable monolithic bend-resistant dental prosthesis intended for restoring a tooth according to the fifth aspect of the present invention comprises a double coronal-root reinforcing supporting part having a root part corresponding to a root part of the tooth to be restored and a coronal part corresponding to a coronal part of the tooth to be restored, and a dental restorative material part corresponding to the coronal part of the tooth to be restored and encapsulating the coronal part of the double coronal-root reinforcing supporting part. The double coronal-root reinforcing supporting part comprises at least one pin and a wire frame.

The at least one pin can comprise at least one conventional pin or at least one tube pin. It can be comprehended by those skilled in the art that the used pins can have different forms suitable for the claimed prosthesis. Further, the at least one pin can be positioned in the coronal part of the double coronal-root reinforcing supporting part or in its root and coronal parts.

A lightweight durable monolithic bend-resistant dental prosthesis intended for restoring a tooth according to the sixth aspect of the present invention comprises a double coronal-root reinforcing supporting part having a root part corresponding to a root part of the tooth to be restored and a coronal part corresponding to a coronal part of the tooth to be restored, and a dental restorative material part corresponding to the coronal part of the tooth to be restored and encapsulating the coronal of the double coronal-root reinforcing supporting part. The double coronal-root reinforcing supporting part comprises a mesh coronal-root tube positioned in the root and coronal parts of the double coronal-root reinforcing supporting part and a mesh coronal-root frame positioned in the root and coronal parts of the double coronal-root reinforcing supporting part. The mesh coronal-root tube is smaller in its lateral size than the mesh coronal-root frame.

A lightweight durable monolithic bend-resistant dental prosthesis intended for restoring a tooth according to the seventh aspect of the present invention comprises a double coronal-root reinforcing supporting part having a root part corresponding to a root part of the tooth to be restored and a coronal part corresponding to a coronal part of the tooth to be restored, and a dental restorative material part corresponding to the coronal part of the tooth to be restored and encapsulating the coronal part of the double coronal-root reinforcing supporting part. The double coronal-root reinforcing supporting part comprises at least one expanding frame and a spring like wire positioned in the coronal part of the double coronal-root reinforcing supporting part. The at least one expanding frame comprises a plurality of wires, and the at least one expanding frame is directed by its wider part to an end part of the, dental restorative material part which is farthest from the root part of the double coronal-root reinforcing supporting part.

It is to note that in some embodiments of this aspect the double coronal-root reinforcing supporting part can comprises more than one spring like wire. Further, an axis of the spring like wire is parallel, perpendicular or positioned at any other suitable angle to a longitudinal axis of the double coronal-root reinforcing supporting part.

Further, the expanding frames comprising a plurality of wires can have different configurations in the double coronal-root reinforcing supporting part, which are the same as for the prosthesis according to the first aspect as described above.

Further, the wires of the least one expanding frame can be U-bent in the middle such that bent ends of the wires form the wider part of the at least one expanding frame, and the wires of the least one expanding frame can be U-bent in the middle such that free ends of the wires form the wider part of the at least one expanding frame, and at least those configurations can be used, which are the same as for the prosthesis according to the first aspect as described above.

A lightweight durable monolithic bend-resistant dental prosthesis intended for restoring a tooth according to the eighth aspect of the present invention comprises a double coronal-root reinforcing supporting part having a root part corresponding to a root part of the tooth to be restored and a coronal part corresponding to a coronal part of the tooth to be restored, and a dental restorative material part corresponding to the coronal part of the tooth to be restored and encapsulating the coronal part of the double coronal-root reinforcing supporting part. The double coronal-root reinforcing supporting part comprises at least one pin and a spring like wire positioned in the coronal part of the double coronal-root reinforcing supporting part.

The at least one pin can comprise at least one conventional pin or t least one tube pin. Further, the at least one pin can be positioned in the coronal part of the double coronal-root reinforcing supporting part or in its root and coronal parts. Further, an axis of the spring like wire is parallel, perpendicular or positioned at any other suitable angle to a longitudinal axis of the double coronal-root reinforcing supporting part.

The at least one pin can be positioned in the root part of the double coronal-root reinforcing supporting part or both in the root and coronal parts of the double coronal root reinforcing supporting part.

A lightweight durable monolithic bend-resistant dental prosthesis intended for restoring a tooth according to the ninth aspect of the present invention comprises a double coronal-root reinforcing supporting part having a root part corresponding to a root part of the tooth to be restored and a coronal part corresponding to a coronal part of the tooth to be restored, and a dental restorative material part corresponding to the coronal part of the tooth to be restored and encapsulating the coronal part of the double coronal-root reinforcing supporting part. The double coronal-root reinforcing supporting part comprises at least one expanding frame and a plurality of rounded wires not contacting each other and positioned in the coronal part of the double coronal-root reinforcing supporting part. The at least one expanding frame comprises a plurality of wires, and the at least one expanding frame is directed by its wider part to an end part of the dental restorative material part which is farthest from the root part of the double coronal-root reinforcing supporting part.

The at least one expanding frame of the double coronal-root reinforcing supporting part can comprise or represent at least one fan-shaped frame, at least one cone-shaped frame, or expanding frames of any other forms suitable for using in the claimed prosthesis.

The rounded wires are positioned parallel or non-parallel to each other, and rounded wires are positioned at the same distance from each other or at different distances from each other.

Further, the expanding frames comprising a plurality of wires can have different configurations in the double coronal-root reinforcing supporting part, which are the same as for the prosthesis according to the first aspect as described above.

Further, the wires of the least one expanding frame can be U-bent in the middle such that bent ends of the wires form the wider part of the at least one expanding frame, and the wires of the least one expanding frame can be U-bent in the middle such that free ends of the wires form the wider part of the at least one expanding frame, and at least those configurations can be used, which are the same as for the prosthesis according to the first aspect as, described above.

A lightweight durable monolithic bend-resistant dental prosthesis intended for restoring a tooth according to the tenth aspect of the present invention comprises a double coronal-root reinforcing supporting part having a root part corresponding to a root part of the tooth to be restored and a coronal part corresponding to a coronal part of the tooth to be restored, and a dental restorative material part corresponding to the coronal part of the tooth to be restored and encapsulating the coronal part of the double coronal-root reinforcing supporting part. The double coronal-root reinforcing supporting part comprises at least one pin and a plurality of rounded wires not contacting each other and positioned in the coronal part of the double coronal-root reinforcing supporting part.

The at least one pin can comprise at least one conventional pin or at least one tube pin. Further, the at least one pin can be positioned in the coronal part of the double coronal-root reinforcing supporting part or in its root and coronal parts. Further, an axis of the spring like wire is parallel, perpendicular or positioned at any other suitable angle to a longitudinal axis of the double coronal-root reinforcing supporting part.

The rounded wires are positioned parallel or non-parallel to each other, and the rounded wires are positioned at the same distance from each other or at different distances from each other.

A lightweight durable monolithic bend-resistant dental prosthesis intended for restoring a tooth according to the eleventh aspect of the present invention comprises a double coronal-root reinforcing supporting part having a root part corresponding to a root part of the tooth to be restored and a coronal part corresponding to a coronal part of the tooth to be restored, and a dental restorative material part corresponding to the coronal part of the tooth to be restored and encapsulating the coronal part of the double coronal-root reinforcing supporting part. The double coronal-root reinforcing supporting part comprises at least one cone-shaped frame positioned in the root and coronal parts of the double coronal-root reinforcing supporting part and a coronal supporting part positioned in the coronal part of the double coronal-root reinforcing supporting part. The at least one cone-shaped frame comprises a plurality of wires, and the at least one cone-shaped frame is directed by its wider part to an end part of the dental restorative material part which is farthest from the root part of the double coronal-root reinforcing supporting part.

The coronal supporting part can comprise at least one of at least one mesh frame, a pin, a spring-like wire, a plurality of rounded wires not contacting each other, and a wire frame

Further, the at least one cone-shaped frame comprising a plurality of wires can have different configurations in the double coronal-root reinforcing supporting part, which are the same as for the prosthesis according to the first aspect as described above.

Further, the wires of the least one cone-shaped frame can be U-bent in the middle such that bent ends of the wires form the wider part of the at least one expanding frame, and the wires of the least one cone-shaped frame can be U-bent in the middle such that free ends of the wires form the wider part of the at least one expanding frame, and at least those configurations can be used, which are the same as for the prosthesis according to the first aspect as described above.

A lightweight durable monolithic bend-resistant dental prosthesis intended for restoring a tooth according to the twelfth aspect of the present invention comprises a coronal-root reinforcing supporting part having a root part corresponding to a root part of the tooth to be restored and a coronal part corresponding to a coronal part of the tooth to be restored, and a dental restorative material part corresponding to the coronal part of the tooth to be restored and encapsulating the coronal part of the coronal-root reinforcing supporting part. The coronal-root reinforcing supporting part comprises at least one cone-shaped frame positioned in the root and coronal parts of the coronal-root reinforcing supporting part. The at least one cone-shaped frame comprises a plurality of wires, arid the at least one cone-shaped frame is directed by its wider part to an end part of the dental restorative material part which is farthest from the root part of the coronal-root reinforcing supporting part.

The at least one cone-shaped frame comprising a plurality of wires can have different configurations in the double coronal-root reinforcing supporting part, which are the same as for the prosthesis according to the first aspect as described above.

Further, the wires of the least one cone-shaped frame can be U-bent in the middle such that bent ends of the wires form the wider part of the at least one expanding frame, and the wires of the least one cone-shaped frame can be U-bent in the middle such that free ends of the wires form the wider part of the at least one expanding frame, and at least those configurations can be used, which are the same as for the prosthesis according to the first aspect as described above.

It is important to note that in any aspect, example or embodiment given in the present disclosure or covered by the claims, at least part of the double coronal-root reinforcing supporting part can be made of a metal material or from a non-metal material, or from a combination of metal and non-metal materials. This means, without limitation, that different parts of the double coronal-root reinforcing supporting part, for example, at least one expanding frame and a mesh coronal-root frame, can be made of different metal or non-metal materials.

Further, it is important to note that in any aspect, example or embodiment given in the present disclosure or covered by the claims, at least part of the double coronal-root reinforcing supporting part or the coronal-root reinforcing supporting part can include wires that are fully or partially crimped along their lengths.

Further, it is important to note that in any aspect, example, or embodiment given in the present disclosure or covered by the claims, at least part of the double coronal-root reinforcing supporting part or the coronal-root reinforcing supporting part can include wires and/or mesh that are fully or partially gold-plated. Furthermore, it is important to note that in any aspect, example or embodiment given in the present disclosure or covered by the claims, at least part of the double coronal-root reinforcing supporting part or the coronal-root reinforcing supporting part can include wires and/or mesh that are fully or partially coated with any other desirable material or materials different from gold.

Although the invention has been described with reference to specific aspects, examples and embodiments, it will be appreciated by those skilled in the art that the invention may be embodied in many other forms.

Reference throughout this specification to “one embodiment” or “an embodiment” or “example” means that a particular feature, structure or characteristic described in connection with the embodiment is included in at least one embodiment of the present invention. Thus, appearances of the phrases “in one embodiment” or “in an example” in various places throughout this specification are not necessarily all referring to the same embodiment or example, but may. Furthermore, the particular features, structures or characteristics may be combined in any suitable manner, as would be apparent to one of ordinary skill in the art from this disclosure, in one or more embodiments.

Similarly, it should be appreciated that in the above description of exemplary embodiments of the invention, various features of the invention are sometimes grouped together in a single embodiment figure, or description thereof for the purpose of streamlining the disclosure and aiding in the understanding of one or more of the various inventive aspects. This method of disclosure, however, not to be interpreted as reflecting an intention that the claimed invention requires more features than are expressly recited in each claim. Rather, as the following claims reflect inventive aspects lie in less than all features of a single foregoing disclosed embodiment. Any claims following the Detailed Description are hereby expressly incorporated into this Detailed Description, with each claim standing on its own as a separate embodiment of this invention.

Furthermore, some embodiments described herein include some but not other features included in other embodiments, combinations of features of different embodiments are meant to be within the scope of the invention, and form different embodiments, as would be understood by those in the art. For example, in the following claims, any of the claimed embodiments can be used in any combination.

Thus, while there has been described what are believed to be the preferred embodiments of the invention, those skilled in the art will recognize that other and further modifications may be made thereto without departing from the scope of, the invention, and it is intended to claim all such changes and modifications as fall within the scope of the invention.

While the present invention has been disclosed with reference to particular details of construction, these should be understood as having been provided by way of example and not as limitations to the scope of the invention.

We claim:

1. A lightweight durable monolithic bend-resistant dental prosthesis intended for restoring a tooth, the prosthesis comprising:
a double coronal-root reinforcing supporting part having a root part corresponding to a root part of the tooth to be restored and a coronal part corresponding to a coronal part of the tooth to be restored, and
a dental restorative material part corresponding to the coronal part of he tooth to be restored,
wherein the dental restorative material part encapsulates the coronal part of the double coronal-root reinforcing supporting part,
wherein the double coronal-root reinforcing supporting part comprises at least one expanding frame and a mesh coronal-root frame positioned in the root and coronal parts of the double coronal-root reinforcing supporting part,
wherein the at least one expanding frame comprises a plurality of wires, and
wherein the at least one expanding frame is directed by its wider part to an end part of the dental restorative material part which is farthest from the root part of the double coronal-root reinforcing supporting part.

2. The lightweight durable monolithic bend-resistant dental prosthesis according to claim 1, wherein the at least one expanding frame comprises at least one fan-shaped frame.

3. The lightweight durable monolithic bend-resistant dental prosthesis according to claim 1, wherein the at least one expanding frame comprises at least one cone-shaped frame.

4. The lightweight durable monolithic bend-resistant dental prosthesis according to claim 1, wherein the wires of the at least one expanding frame are connected by their ends in the root part of the double coronal-root reinforcing supporting part such that they form the wider part of the at least one expanding frame ending in the coronal part of the double coronal-root reinforcing supporting part.

5. The lightweight durable monolithic bend-resistant dental prosthesis according to claim 1, wherein the wires of the at least one expanding frame are connected by their ends in the root part of the double coronal-root reinforcing supporting part such that they form the wider part of the at least one expanding frame ending in the root part of the double coronal-root reinforcing supporting part.

6. The lightweight durable monolithic Send-resistant dental prosthesis according to claim 1, wherein the wires of the at least one expanding frame are connected by their ends in the coronal part of the double coronal-root reinforcing supporting part such that they form the wider part of the at least one expanding frame ending in the coronal part of the double coronal-root reinforcing supporting part.

7. The lightweight durable monolithic bend-resistant dental prosthesis according to claim 1, wherein the wires of the at least one expanding frame are U-bent in the middle such that bent ends of the wires are located at a distance from each other and form the wider part of the at least one expanding frame ending in the coronal part of the double coronal-root reinforcing supporting part, and free ends of the wires, opposite to the bent parts, are connected in the root part of the, double coronal-root reinforcing supporting part.

8. The lightweight durable monolithic bend-resistant dental prosthesis according to claim 1, wherein the wires of the at least one expanding frame are U-bent in the middle such that bent ends of the wires are located at a distance from each other and form the wider part of the at least one expanding frame ending in the coronal part of the double coronal-root reinforcing supporting, part, and free ends of the wires, opposite to the bent parts, are connected in the coronal part of the double coronal-root reinforcing supporting part.

9. The lightweight durable monolithic bend-resistant dental prosthesis according to claim 1, wherein the wires of the at least one expanding frame are U-bent in the middle such that bent ends of the wires are located at a distance from each other and form the wider part of the at least one expanding frame ending in the root part of the double coronal-root reinforcing supporting part, and free ends of the wires, opposite to the bent parts, are connected in the root part of the double coronal-root reinforcing supporting part.

10. The lightweight durable monolithic bend-resistant dental prosthesis according to claim 1, wherein the wires of the at least one expanding frame are U-bent in the middle such that bent ends of the wires are connected in the root part of the double coronal-root reinforcing supporting part, and free ends of the wires, opposite to the bent parts, are located at a distance from each other and form the wider part of the at least one expanding frame ending in the coronal part of the double coronal-root reinforcing supporting part.

11. The lightweight durable monolithic bend-resistant dental prosthesis according claim 1, wherein the wires of the at least one expanding frame are U-bent in the middle such that bent ends of the wires are connected in the root part of the double coronal-root reinforcing supporting part, and free ends of the wires, opposite to the bent parts, are located at a distance from each other and form the wider part of the at least one expanding frame ending in the root part of the double coronal-root reinforcing supporting part,

12. The lightweight durable monolithic bend-resistant dental prosthesis according to claim 1, wherein the wires of the at least one expanding frame are U-bent in the middle such that bent ends of the wires are connected in the coronal part of the double coronal-root reinforcing supporting part, and free ends of the wires, opposite to the bent parts, are located at a distance from each other and form the wider part of the at least one expanding frame ending in the coronal part of the double coronal-root reinforcing supporting part.

13. The lightweight durable monolithic bend-resistant dental prosthesis according to claim 1, wherein at least part of the double coronal-root reinforcing supporting part is made of one of metal, non-metal and a combination of metal and non-metal materials.

14. A lightweight durable monolithic bend-resistant dental prosthesis intended for restoring a tooth, the prosthesis comprising:
a double coronal-root reinforcing supporting part having a root part corresponding to a root part of the tooth to be restored and a coronal part corresponding to a coronal part of the tooth to be restored, and
a dental restorative material part corresponding to the coronal part of the tooth to be restored,
wherein the dental restorative material part encapsulates the coronal part of the double coronal-root reinforcing supporting part,
wherein the double coronal-root reinforcing supporting part comprises at least one pin and a mesh coronal-root frame positioned in the root and coronal parts of the double coronal-root reinforcing supporting part.

15. The lightweight durable monolithic bend-resistant dental prosthesis according to claim 14, wherein the at least one pin is positioned in the root part of the double coronal-root reinforcing supporting part.

16. The lightweight durable monolithic bend-resistant dental prosthesis according to claim 14, wherein the at least one pin is positioned in the root and coronal parts of the double coronal-root reinforcing supporting part.

17. The lightweight durable monolithic bend-resistant dental prosthesis according to claim 14, wherein at least part of the double coronal-root reinforcing supporting, part made of one of metal, non-metal and a combination of metal and non-metal materials.

18. A lightweight durable monolithic bend-resistant dental prothesis intended for restoring a tooth, the prosthesis comprising:
a coronal-root reinforcing supporting part having a root part corresponding to a root part of the tooth to be restored and a coronal part corresponding to a coronal part of the tooth to be restored, and
a dental restorative material part corresponding to the coronal part of the tooth to be restored,
wherein the dental restorative material part encapsulates the coronal of the coronal-root reinforcing supporting part,
wherein the coronal-root reinforcing supporting part comprises a mesh coronal-root frame positioned in the root and coronal parts of the double coronal-root reinforcing supporting part.

19. The lightweight durable monolithic bend-resistant dental prosthesis according to claim 18, wherein at least part of the double coronal-root reinforcing supporting part is made of one of metal non-metal and a combination of metal and non-metal materials.

20. A lightweight durable monolithic bend-resistant dental prosthesis intended for restoring a tooth, the prosthesis comprising:
a double coronal-root reinforcing supporting part having a root part corresponding to a root part of the tooth to be restored and a coronal part corresponding to a coronal part of the tooth to be restored, and
a dental restorative material part corresponding to the coronal part of the tooth to be restored,
wherein the dental restorative material part encapsulates the coronal part of the double coronal-root reinforcing supporting part,
wherein the double coronal-root reinforcing supporting part comprises at least one expanding frame and a wire frame,
wherein the at least one expanding frame comprises a plurality of wires, and
wherein the at least one expanding frame is directed by its wider part to an end part of the dental restorative material part which is farthest from the root part of the double coronal-root reinforcing supporting part.

21. The lightweight durable monolithic end-resistant dental prosthesis according to claim 20, wherein the wire frame has a dome-shaped form.

22. The lightweight durable monolithic bend-resistant dental prosthesis according to claim 20, wherein the at least one expanding frame comprises at least one fan-shaped frame.

23. The lightweight durable monolithic bend-resistant dental prosthesis according to claim 20, wherein the at least one expanding frame comprises at least one cone-shaped frame.

24. The lightweight durable monolithic bend-resistant dental prosthesis according to claim 20, wherein the wire frame is positioned in the coronal part of the double coronal-root reinforcing supporting part.

25. The lightweight durable monolithic bend-resistant dental prosthesis according to claim 20, wherein the wire frame is positioned in the root and coronal parts of the double coronal-root reinforcing supporting part.

26. The lightweight durable monolithic bend-resistant dental prosthesis according to claim 20, wherein the wires of the at least one expanding frame are connected by their ends in the root part of the double coronal-root reinforcing supporting part such that they form the wider part of the at least one expanding frame ending in the coronal part of the double coronal-root reinforcing supporting part.

27. The lightweight durable monolithic bend-resistant dental prosthesis according to claim 20, wherein the wires of the at least one expanding frame are connected by their ends in the root part of the double coronal-root reinforcing supporting part such that they form the wider part of the at least one expanding frame ending in the root part of the double coronal-root reinforcing supporting part.

28. The lightweight durable monolithic bend-resistant dental prosthesis according to claim 20, wherein the wires of the at least one, expanding frame are U-bent in the middle such that bent ends of the wires are located at a distance from each other and form the wider part of the at least one expanding frame ending in the coronal part of the double coronal-root reinforcing supporting part, and free ends of the wires, opposite to the bent parts, are connected in the root part of the double coronal-root reinforcing supporting part.

29. The lightweight durable monolithic bend-resistant dental prosthesis according to claim 20, wherein the wires of the at least one expanding frame are U-bent in the middle such that bent ends of the wires are located at a distance from each other and form the wider part of the at least one expanding frame ending in the root part of the double coronal-root reinforcing supporting part, and free ends of the wires, opposite to the bent parts, are connected in the root part of the double coronal-root reinforcing supporting part.

30. The lightweight durable monolithic bend-resistant dental prosthesis according to claim 20, wherein the wires of the at least one expanding frame are U-bent in the middle such that bent ends of the wires are connected in the root part of the double coronal-root reinforcing supporting part, and free ends of the wires, opposite to the bent parts, are located at a distance from each other and form the wider part of the at least one expanding frame ending in the coronal part of the double coronal-root reinforcing supporting part.

31. The lightweight durable monolithic bend-resistant dental prosthesis according to claim 20, wherein the wires of the at least one expanding frame are U-bent in the middle such that bent ends of the wires are connected in the root part of the double coronal-root reinforcing supporting part, and free ends of the wires, opposite to the bent parts, are located at a distance from each other and form the wider part of the at least one expanding frame ending in the root part of the double coronal-root reinforcing supporting part,

32. The lightweight durable monolithic bend-resistant dental prosthesis according to claim 20, wherein at least part of the double coronal-root reinforcing supporting part made of one of metal, non-metal and a combination of metal and non-metal materials.

33. A lightweight durable monolithic bend-resistant dental prosthesis intended for restoring a tooth, the prosthesis comprising:
a double coronal-root reinforcing supporting part having a root part corresponding to a root part of the tooth to be restored and a coronal part corresponding to a coronal part of the tooth to be restored, and
a dental restorative material part corresponding to the coronal part of the tooth to be restored,
wherein the dental restorative material part encapsulate the coronal part of the double coronal-root reinforcing supporting part,
wherein the double coronal-root reinforcing supporting part comprises at least one pin and a wire frame.

34. The lightweight durable monolithic bend-resistant dental prosthesis according to claim 33, wherein the at least one pin comprises at least one conventional pin.

35. The lightweight durable, monolithic bend-resistant dental prosthesis according to claim 33, wherein the at least one pin comprises at least one tube pin.

36. The lightweight durable monolithic bend-resistant dental prosthesis according to claim 33, wherein the at least one pin is positioned in the coronal part of the double coronal-root reinforcing supporting part.

37. The lightweight durable monolithic bend-resistant dental prosthesis according to claim 33, wherein the at least one pin is positioned in the root and coronal parts of the double coronal-root reinforcing supporting part.

38. The lightweight durable monolithic bend-resistant dental prosthesis according to claim 33, wherein at least part of the double coronal-root reinforcing supporting part is made of one of metal, non-metal and a combination of metal and non-metal materials.

39. A lightweight durable monolithic bend-resistant dental prosthesis intended for restoring a tooth, the prosthesis comprising:
a double coronal-root reinforcing supporting part having a root part corresponding to a root part of the tooth to be restored and a coronal part corresponding to a coronal part of the tooth to be restored, and
a dental restorative material part corresponding to the coronal part of the tooth to be restored.
wherein the dental restorative material part encapsulates the coronal of the double coronal-root reinforcing supporting part,
wherein the double coronal-root reinforcing supporting part comprises a mesh coronal-root tube positioned in the root and coronal parts of the double coronal-root reinforcing supporting part and a mesh coronal-root frame positioned in the root and coronal parts of the double coronal-root reinforcing supporting part.

40. The lightweight durable monolithic bend-resistant dental prosthesis according to claim 39, wherein at least part of the double coronal-root reinforcing supporting part is made of one of metal, non-metal and a combination of metal and non-metal materials.

41. A lightweight durable monolithic bend-resistant dental prosthesis intended for restoring a tooth, the prosthesis comprising:
a double coronal-root reinforcing supporting part having a root part corresponding to a root part of the tooth to be restored and a coronal part corresponding to a coronal part of the tooth to be restored, and
a dental restorative material part corresponding to the coronal part of the tooth to be restored,
wherein the dental restorative material part encapsulates the coronal part of the double coronal-root reinforcing supporting part,
wherein the double coronal-root reinforcing supporting part comprises at least one expanding frame and a spring like wire positioned in the coronal part of the double coronal-root reinforcing supporting part,
wherein the at least one expanding frame comprises a plurality of wires, and wherein the at least one expanding frame is directed by its wider part to an end part of the dental restorative material part which is farthest from the root part of the double coronal-root reinforcing supporting part.

42. The lightweight durable monolithic bend-resistant dental prosthesis according to claim 41, wherein an axis of the spring like wire is parallel to a longitudinal axis of the double coronal-root reinforcing supporting part.

43. The lightweight durable monolithic bend-resistant dental prosthesis according to claim 41, wherein an axis of the spring like wire is perpendicular to a longitudinal axis of the double coronal-root reinforcing supporting part.

44. The lightweight durable monolithic bend-resistant dental prosthesis according to claim 41, wherein the wires of the at least one expanding frame are connected by their ends in the root part of the double coronal-root reinforcing supporting part such that they form the wider part of the at least one expanding frame ending in the coronal part of the double coronal-root reinforcing supporting part.

45. The lightweight durable monolithic bend-resistant dental prosthesis according to claim 41, wherein the wires of the at least one expanding frame are connected by their ends in the root part of the double coronal-root reinforcing supporting part such that they form the wider part of the at least one expanding frame ending in the root part of the double coronal root reinforcing supporting part.

46. The lightweight durable, monolithic bend-resistant dental prosthesis according to claim 41, wherein the wires of the at least one expanding frame are connected by their ends in the coronal part of the double coronal-root reinforcing supporting part such that they form the wider part of the at least one expanding frame ending in the coronal part of the double coronal-root reinforcing supporting part.

47. The lightweight durable monolithic bend-resistant dental prosthesis according to claim 41, wherein the wires of the at least one expanding frame are U-bent in the middle such that bent ends of the wires are located at a distance from each other and form the wider part of the at least one expanding frame ending in the coronal part of the double coronal-root reinforcing supporting part, and free ends of the wires, opposite to the bent parts, are connected in the root part of the double coronal-root reinforcing supporting part.

48. The lightweight durable monolithic bend-resistant dental prosthesis according to claim 41, wherein the wires of the at least one expanding frame are U-bent in the middle such that bent ends of the wires are located at a distance from each other and form the wider part of the at least one expanding frame ending in the coronal part of the double coronal-root reinforcing supporting part, and free ends of the wires, opposite to the bent parts, are connected in the coronal part of the double coronal-root reinforcing supporting part.

49. The lightweight durable monolithic bend-resistant dental prosthesis according to claim 41, wherein the wires of the at least one expanding frame are U-bent in the middle such that bent ends of the wires are located at a distance from each other and form the wider part of the at least one expanding frame ending in the root part of the double coronal-root reinforcing supporting part, and free ends of the wires, opposite to the bent parts, are connected in the root part of the double coronal-root reinforcing supporting part.

50. The lightweight durable monolithic bend-resistant dental prosthesis according to claim 41, wherein the wires of the at least one expanding frame are U-bent in the middle such that bent ends of the wires are connected in the root part of the double coronal-root reinforcing supporting part, and free ends of the wires, opposite to the bent parts, are located at a distance from each other and form the wider part of the at least one expanding frame ending in the coronal part of the double coronal-root reinforcing supporting part.

51. The lightweight durable monolithic bend-resistant dental prosthesis according to claim 41, wherein the wires of the at least one expanding frame are U-bent in the middle such that bent ends of the wires are connected in the root part of the double coronal-root reinforcing supporting part, and free ends of the wires, opposite to the bent parts, are located at a distance from each other and form the wider part of the at least one expanding frame ending in the root part of the double coronal-root reinforcing supporting part.

52. The lightweight durable monolithic bend-resistant dental prosthesis according to claim 41, wherein the wires of the, at least one expanding frame are U-bent in the middle such that bent ends of the wires are connected in the coronal part of the double coronal-root reinforcing supporting part, and free ends of the wires, opposite to the bent parts, are located at a distance from each other and form the wider part of the at least one expanding frame ending in the coronal part of the double coronal-root reinforcing supporting part.

53. The lightweight durable monolithic bend-resistant dental prosthesis according to claim 41, wherein at least part of the double coronal-root reinforcing supporting part is made of one of metal, non-metal and a combination of metal and non-metal materials.

54. A lightweight durable monolithic bend-resistant dental prosthesis intended for restoring a tooth, the prosthesis comprising:
a double coronal-root reinforcing supporting, part having a root part corresponding to a root part of the tooth to be restored and a coronal part corresponding to a coronal part of the tooth to be restored, and
a dental restorative material part corresponding to the coronal part of the tooth to be restored,
wherein the dental restorative material part encapsulates the coronal part of the double coronal-root reinforcing supporting part
wherein the double coronal-root reinforcing supporting part comprises at least one pin and a spring, like wire positioned in the coronal part of the double coronal-root reinforcing supporting part.

55. The lightweight durable monolithic bend-resistant dental prosthesis according to claim 54, wherein the at least one pin comprises at least one conventional pin,

56. The lightweight durable monolithic bend-resistant dental prosthesis according to claim 54, wherein the at least one pin comprises at least one tube pin.

57. The lightweight durable monolithic bend-resistant dental prosthesis according to claim 54, wherein an axis of the spring like wire is, parallel to a longitudinal axis of the double coronal root reinforcing supporting part.

58. The lightweight durable monolithic bend-resistant dental prosthesis according to claim 54, wherein an axis of the spring like wire is perpendicular to a longitudinal axis of the double coronal-root reinforcing supporting part.

59. The lightweight durable monolithic bend-resistant dental prosthesis according to claim 54, wherein the at least one pin is positioned in the coronal part of the double coronal-root reinforcing supporting part.

60. The lightweight durable monolithic bend-resistant dental prosthesis according to claim 54, wherein the at least one pin is positioned in the root and coronal parts of the double coronal root reinforcing supporting part.

61. The lightweight durable monolithic bend-resistant dental prosthesis according to claim 54, wherein at least part of the double coronal-root reinforcing supporting part is made of one of metal, non-metal and a combination of metal and non-metal materials.

62. A lightweight durable monolithic bend-resistant dental prosthesis intended for restoring a tooth, the prosthesis comprising:
a double coronal-root reinforcing supporting part having a root part corresponding to a root part of the tooth to be restored and a coronal part corresponding to a coronal part of the tooth to be restored, and
a dental restorative material part corresponding to the coronal part of the tooth to be restored,
wherein the dental restorative material part encapsulates the coronal part of the double coronal-root reinforcing supporting part,
wherein the double coronal-root reinforcing supporting part comprises at least one expanding frame and a plurality of rounded wires not contacting each other and positioned in the coronal part of the double coronal-root reinforcing supporting part,
wherein the at least one expanding frame comprises a plurality of wires, and
wherein the at least one expanding frame is directed by its wider part to an end part of the dental restorative material part which is farthest from the root part of the double coronal-root reinforcing supporting part.

63. The lightweight durable monolithic bend-resistant dental prosthesis according to claim 62, wherein the at least one expanding frame comprises at least one fan-shaped frame.

64. The lightweight durable monolithic bend-resistant dental prosthesis according to claim 62, wherein the at least one expanding frame comprises at least one cone-shaped frame.

65. The lightweight durable monolithic bend-resistant dental prosthesis according to claim 62, wherein the rounded wires are positioned parallel.

66. The lightweight durable monolithic bend-resistant dental prosthesis according to claim 62, wherein the rounded wires are positioned non-parallel to each other.

67. The lightweight durable monolithic bend-resistant dental prosthesis according to claim 62, wherein the rounded wires are positioned at the same distance from each other.

68. The lightweight durable monolithic bend-resistant dental prosthesis according to claim 62, wherein the wires of the at least one expanding frame are connected by their ends in the root part of the double coronal-root reinforcing supporting part such that they form the wider part of the at least one expanding frame ending in the coronal part of the double coronal-root reinforcing supporting part.

69. The lightweight durable monolithic bend-resistant dental prosthesis according to claim 62, wherein the wires of the at least one expanding frame are connected by their ends in the root part of the double coronal-root reinforcing supporting part such that they form the wider part of the at least one expanding frame ending in the root part of the double coronal-root reinforcing supporting part.

70. The lightweight durable monolithic bend-resistant dental prosthesis according to claim 62, wherein the wires of the at least one expanding frame are connected by their ends in the coronal part of the double coronal-root reinforcing supporting part such that they form the wider part of the at least one expanding frame ending in the coronal part of the double coronal-root reinforcing supporting part.

71. The lightweight durable monolithic bend-resistant dental prosthesis according to claim 62, wherein the wires of the at least one expanding frame are U-bent in the middle such that bent ends of the wires are located at a distance from each other and form the wider part of the at least one expanding frame ending in the coronal part of the double coronal-root reinforcing supporting part, and free ends of the wires, opposite to the bent parts, are connected in the root part of the double coronal-root reinforcing supporting part,

72. The lightweight durable monolithic bend-resistant dental prosthesis according to claim 62, wherein the wires of the at least one expanding frame are U-bent in the middle such that bent ends of the wires are located at a distance from each other and form the wider part of the at least one expanding frame ending in the coronal part of the double coronal-root reinforcing supporting part, and free ends of the wires, opposite to the bent parts, are connected in the coronal part of the double coronal-root reinforcing supporting part.

73. The lightweight durable monolithic bend-resistant dental prosthesis according to claim 62, wherein the wires of the at least one expanding frame are U-bent in the middle such that bent ends of the wires are located at a distance from each other and form the wider part of the at least one expanding frame ending in the root part of the double coronal-root reinforcing supporting part, and free ends of the wires, opposite to the bent parts, are connected in the root part of the double coronal-root reinforcing supporting part.

74. The lightweight durable monolithic bend-resistant dental prosthesis according to claim 62, wherein the wires of the at least one expanding frame are U-bent in the middle such that bent ends of the wires are connected in the root part of the double coronal-root reinforcing supporting part, and free ends of the wires, opposite to the bent parts, are located at a distance from each other and form the wider part of the at least one expanding frame ending in the coronal part of the double coronal-root reinforcing supporting part.

75. The lightweight durable monolithic bend-resistant dental prosthesis according to claim 62, wherein the wires of the at least one expanding frame are U-bent in the middle such that bent ends of the wires are connected in the root part of the double coronal-root reinforcing supporting part, and free ends of the wires, opposite to the bent parts, are located at a distance from each other and form the wider part of the at least one expanding frame ending in the root part of the double coronal-root reinforcing supporting part.

76. The lightweight durable monolithic bend-resistant dental prosthesis according to claim 62, wherein the wires of the at least one expanding frame are U-bent in the middle such that bent ends of the wires are connected in the coronal part of the double coronal-root reinforcing supporting part, and free ends of the wires, opposite to the bent parts, are located at a distance from each other and form the wider part of the at least one expanding frame ending in the coronal part of the double coronal-root reinforcing supporting part.

77. The lightweight durable monolithic bend-resistant dental prosthesis according to claim 62, wherein at least part of the double coronal-root reinforcing supporting part is made of one of metal, non-metal and a combination of metal and non-metal materials.

78. A lightweight durable monolithic bend-resistant dental prosthesis intended for restoring a tooth, the prosthesis comprising:
a double coronal-root reinforcing supporting part having a root part corresponding to a root part of the tooth to be restored and a coronal part corresponding to a coronal part of the tooth to be restored, and
a dental restorative material part corresponding to the coronal part of the tooth to be restored,
wherein he dental restorative material part encapsulates the coronal part of the double coronal-root reinforcing supporting part,
wherein the double coronal-root reinforcing supporting part comprises at least one pin and a plurality of rounded wires not contacting each, other and positioned in the coronal part of the double coronal-root reinforcing supporting part.

79. The lightweight durable monolithic bend-resistant dental prosthesis according to claim 78 wherein the at least one pin comprises at least one conventional pin.

80. The lightweight durable monolithic bend-resistant dental prosthesis according to clap 78, wherein the at least one pin comprises at least one tube pin.

81. The lightweight durable monolithic bend-resistant dental prosthesis according to claim 78, wherein the rounded wires are positioned parallel to each other.

82. The lightweight durable monolithic bend-resistant dental prosthesis according to claim 78, wherein the rounded wires are positioned at the same distance from each other.

83. The lightweight durable monolithic bend-resistant dental prosthesis according to claim 78, wherein the at least one pin is positioned in the coronal part of the double coronal-root reinforcing supporting part.

84. The lightweight durable monolithic bend-resistant dental prosthesis according to claim 78, wherein the at least one pin is positioned in the root and coronal parts of the double coronal-root reinforcing supporting part.

85. The lightweight durable monolithic bend-resistant dental prosthesis according to claim 78, wherein at least part of the double coronal-root reinforcing supporting part made of one, of metal, non-metal and a combination of metal and non-metal materials.

86. A lightweight durable monolithic bend-resistant dental prosthesis intended for restoring a tooth, the prosthesis comprising:
a double coronal-root reinforcing supporting part having a root part corresponding to a root part of the tooth to be restored and a coronal part corresponding to a coronal part of the tooth to be restored, and
a dental restorative material part corresponding to the coronal part of the tooth to be restored,
wherein the dental restorative material part encapsulate the coronal part of the double coronal-root reinforcing supporting part,
wherein the double coronal-root reinforcing supporting part comprises at least one cone-shaped frame positioned in the root and coronal parts of the double coronal-root reinforcing supporting part and a coronal supporting part positioned in the coronal part of the double coronal-root reinforcing supporting part,
wherein the at least one cone-shaped frame comprises a plurality of wires, and
wherein the at least one cone-shaped frame is directed by its wider part to an end part of the dental restorative material part which is farthest from the root part of the double coronal-root reinforcing supporting part.

87. The lightweight durable monolithic bend-resistant dental prosthesis according to claim 86, wherein the coronal supporting part comprises at least one of at least one mesh frame, a pin, a spring-like wire, a plurality of rounded wires not contacting each other, and a wire frame.

88. The lightweight durable monolithic bend-resistant dental prosthesis according to claim 86, wherein the wires of the at least one cone-shaped frame are connected by their ends in the root part of the double coronal-root reinforcing supporting part such that they form the wider part of the at least one cone-shaped frame ending in the coronal part of the double coronal-root reinforcing supporting part.

89. The lightweight durable monolithic bend-resistant dental prosthesis according to claim 86, wherein the wires of the at least one cone-shaped frame are connected by their ends in the root part of the double coronal root reinforcing supporting part such that they form the wider part of the at least one cone-shaped frame ending in he root part of the double coronal-root reinforcing supporting part,

90. The lightweight durable monolithic bend-resistant dental prosthesis according to claim 86, wherein the wires of the at least one cone-shaped frame are connected by their ends in the coronal part of the double coronal-root reinforcing supporting part such that they form the wider part of the at least one cone-shaped frame ending in the coronal part of the double coronal-root reinforcing supporting part.

91. The lightweight durable monolithic bend-resistant dental prosthesis according to claim 86, wherein the wires of the at least one cone-shaped frame are U-bent in the middle such that bent ends of the wires are located at a distance from each other and form the wider part of the at least one cone-shaped frame ending in the coronal part of the double coronal-root reinforcing supporting part, and free ends of the wires, opposite to the bent parts, are connected in the root part of the double coronal-root reinforcing supporting part.

92. The lightweight durable monolithic bend-resistant dental prosthesis according to claim 86, wherein the wires of the at least one cone-shaped frame are U-bent in the middle such that bent ends of the wires are located at a distance from each other and form the wider part of the at least one cone-shaped frame, ending in the coronal part of the double coronal-root reinforcing supporting part, and free ends of the wires, opposite to the bent parts, are connected in the coronal part of the double coronal-root reinforcing supporting part.

93. The lightweight durable monolithic bend-resistant dental prosthesis according to claim 860, wherein the wires of the at least one cone-shaped frame are U-bent in the middle such that bent ends of the wires are located at a distance from each other and form the wider part of the at least one cone-shaped frame ending in the root part of the double coronal-root reinforcing supporting part, and free ends of the wires, opposite to the bent parts, are connected in the root part of the double coronal-root reinforcing supporting part.

94. The lightweight durable monolithic bend-resistant dental prosthesis according to claim 86, wherein the wires of the at least one cone-shaped frame are U-bent in the middle such that bent ends of the wires are connected in the root part of the double coronal-root reinforcing supporting part, and free ends of the wires, opposite to the bent parts, are located at a distance from each other and form the wider part of the at least one cone-shaped frame ending in the coronal part of the double coronal-root reinforcing supporting part.

95. The lightweight durable monolithic bend-resistant dental prosthesis according to claim 86, wherein the wires of the at least one cone-shaped frame are U-bent in the middle such that bent ends of the wires are connected in the root part of the double coronal-root reinforcing supporting part, and free ends of the wires, opposite to the bent parts, are located at a distance from each other and form the wider part of the at least one cone-shaped frame ending in the root part of the double coronal-root reinforcing supporting part.

96. The lightweighit durable monolithic bend-resistant dental prosthesis according to claim 86, wherein the wires of the at least one cone-shaped frame are U-bent in the middle such that bent ends of the wires are connected in the coronal part of the double coronal-root reinforcing supporting part, and free ends of the wires, opposite to the bent parts, are located at a distance from each other and form the wider part of the at least one cone-shaped frame ending in the coronal part of the double coronal-root reinforcing supporting part.

97. The lightweight durable monolithic bend-resistant dental prosthesis according to claim 86, wherein at least part of the double coronal-root reinforcing supporting part is made of one of metal, non-metal and a combination of metal and non-metal materials.

98. A lightweight durable monolithic bond-resistant dental prosthesis intended for restoring a tooth, the prosthesis comprising:
a coronal-root reinforcing supporting part having a root part corresponding to a root part of the tooth to be restored and a coronal part corresponding to a coronal part of the tooth to be restored, and
a dental restorative material part corresponding to the coronal part of the tooth to be restored,
wherein the dental restorative material part encapsulate the coronal part of the coronal-root reinforcing supporting part,
wherein the coronal-root reinforcing supporting part comprises at least one cone-shaped frame positioned in the root and coronal parts of the coronal-root reinforcing supporting part,
wherein the at least one cone-shaped frame comprises a plurality of wires, and
wherein the at least one cone-shaped frame is directed by its wider part to an end part of the dental restorative material part which is farthest from the root part of the coronal root reinforcing supporting part.

99. The lightweight durable monolithic bend-resistant dental prosthesis according to claim 98, wherein the wires of the at least one cone-shaped frame are connected by their ends in the root part of the double coronal-root reinforcing supporting part such that they form the wider part of the at least one cone-shaped frame ending in the coronal part of the double coronal-root reinforcing supporting part.

100. The lightweight durable monolithic bend-resistant dental prosthesis according to claim 98, wherein the wires of the at least one cone-shaped frame, are connected by their ends in the root part of the double coronal-root reinforcing supporting part such that they form the wider part of the at least one cone-shaped frame ending in the root part of the double coronal-root reinforcing supporting part.

101. The lightweight durable monolithic bend-resistant dental prosthesis according to claim 98, wherein the wires of the at least one cone-shaped frame are connected by their ends in the coronal part of the double coronal-root reinforcing supporting part such that they form the wider part of the at least one cone-shaped frame ending in the coronal part of the double coronal-root reinforcing supporting part.

102. The lightweight durable monolithic bend-resistant dental prosthesis according to claim 98, wherein the wires of the at least one cone-shaped frame are U-bent in the middle such that bent ends of the wires are located at a distance from each other and form the wider part of the at least one cone-shaped frame ending in the coronal part of the double coronal-root reinforcing supporting part, and free ends of the wires, opposite to the bent parts, are connected in the root part of the double coronal-root reinforcing supporting part,

103. The lightweight durable monolithic bend-resistant dental prosthesis according to claim 98, wherein the wires of the at least one cone-shaped frame are U-bent in the middle such that bent ends of the wires are located at a distance from each other and form the wider part of the at least one cone-shaped frame ending in the coronal part of the double coronal-root reinforcing supporting part, and free ends of the wires, opposite to the bent parts, are connected in the coronal part of the double coronal-root reinforcing supporting part.

104. The lightweight durable monolithic bend-resistant dental prosthesis according to claim 98, wherein the wires of the at least one cone-shaped frame are U-bent in the middle such that bent ends of the wires are located at a distance from each other and form the wider part of the at least one cone-shaped frame ending in the root part of the double coronal-root reinforcing supporting part, and free ends of the wires, opposite to the bent parts, are connected in, the root part of the double coronal-root reinforcing supporting part.

105. The lightweight durable monolithic bend-resistant dental prosthesis according to claim 98, wherein the wires of the at least one cone-shaped frame are U-bent in the middle such that bent ends of the wires are connected in the root part of the double coronal-root reinforcing supporting part, and free ends of the wires, opposite to the bent parts, are located at a distance from each other and form the wider part of the at least one cone-shaped frame ending in the coronal part of the double coronal-root reinforcing supporting part.

106. The lightweight durable monolithic bend-resistant dental prosthesis according to claim 98, wherein the wires of the at least one cone-shaped frame are U-bent in the middle such that bent ends of the wires, are connected in the root part of the double coronal-root reinforcing supporting part, and free ends of the wires, opposite to the bent parts, are located at a distance from each other and form the wider part of the at least one cone-shaped frame ending in the root part of the double coronal-root reinforcing supporting part.

107. The lightweight durable monolithic bend-resistant dental prosthesis according to claim 98, wherein the wires of the at least one cone-shaped frame are U-bent in the middle such that bent ends of the wires are connected in the coronal part of the double coronal-root reinforcing supporting part, and free ends of the wires, opposite to the bent parts, are located at a distance from each other and form the wider part of the at least one cone-shaped frame ending in the coronal part of the double coronal-root reinforcing supporting part.

108. The lightweight durable monolithic bend-resistant dental prosthesis according to claim 98, wherein at least part of the double coronal-root reinforcing supporting part is made of one of metal, non-metal and a combination of metal and non-metal materials.
